(19) United States
(12) Patent Application Publication
(10) Pub. No.: US 2026/0064113 A1
(43) Pub. Date: Mar. 5, 2026

(54) Epidermal Multimodal Human-Drone Interfacing System and A Method of Using the Same

(71) Applicant: City University of Hong Kong, Hong Kong (HK)

(72) Inventors: Xinge YU, Hong Kong (HK); Chun Ki YIU, Hong Kong (HK); Yiming LIU, Hong Kong (HK); Wooyoung PARK, Hong Kong (HK)

(21) Appl. No.: 19/317,161

(22) Filed: Sep. 3, 2025

Related U.S. Application Data
(60) Provisional application No. 63/690,319, filed on Sep. 4, 2024.

(51) Int. Cl. G05D 1/223; B64U 10/13; B64U 101/30; G05D 109/25; G06F 3/01

(52) U.S. Cl. CPC G05D 1/2234; G06F 3/014; G06F 3/016; G06F 3/017; B64U 10/13; B64U 2101/30; B64U 2201/20; G05D 2109/254

(57) ABSTRACT

The present invention provides an epidermal multimodal human-drone interfacing system which enable drone operation in dynamic and intricate environments. The interfacing system comprises: a base station configured to: receive hand orientation data of a user and obstacle data within a caution distance from a drone; and generate, on basis of a correlation of the hand orientation data and the obstacle data, respective control commands for providing tactile feedback to a user's fingers, stimulating multiple muscle groups of the user's arm and controlling the drone; a drone control tactile feedback (DCTF) module configured to: collect the hand orientation data of the user and deliver the tactile feedback to the user's fingers; and a neuromuscular electrical stimulation force feedback (NMESF) module configured to: collect obstacle data within the caution distance from the drone and deliver stimulation current to the multiple muscle groups of the user's arm.

### CROSS-REFERENCE TO RELATED APPLICATIONS

The present application claims priority from the U.S. Provisional Patent Application No. 63/690,319 filed on Sep. 4, 2024, and the disclosure of which is incorporated herein by reference in its entirety.

### FIELD OF THE INVENTION

The present invention generally relates to drone control technologies. More specifically the present invention relates to an epidermal multimodal human-drone interfacing system and a method of using the same.

### BACKGROUND OF THE INVENTION

Unmanned Aerial Vehicle (UAV), commonly referred to as “Drone”, have garnered considerable attention and substantial market expansion in recent years. An increasing number of drones are being integrated into various facets of people's daily lives, encompassing domains such as transportation, infrastructure, and other sectors. Despite significant advancements in artificial intelligence and drone control algorithms in recent years, fully autonomous drone systems are still deemed unsuitable for navigating drone in complex and rapidly changing environments. Human operators demonstrate better robustness in emergencies or dynamic environments, and human involvement continues to offer significant benefits. This has resulted in increased focus on the development of drone control methodologies.

Presently, the predominant control methods for commercial drones involve joystick-based controllers or touch interfaces, such as smartphones. However, these conventional control methods encounter challenges related to increased control complexity, prolonged training periods, and higher cognitive demand. In response to these challenges, an increasing number of researchers have devised various novel intuitive control methods for drone operation. These methods include Brain-Computer Interface (BCI) systems based on Electroencephalography (EEG), speech control, gesture control based on Electromyography (EMG), computer vision gesture classification, and gesture recognition utilizing mechanical sensors or inertial measurement units (IMU). Some studies have even integrated multiple control methods to enhance overall performance. These intuitive control approaches have demonstrated the ability to reduce operator training time due to their high learnability, minimizing cognitive load and allowing users to focus on flight tasks. Moreover, they offer a heightened sense of control and driving satisfaction. Unfortunately, the majority of these systems still necessitate bulky or rigid devices, posing challenges to the wearability of the system.

The progression of drone control methodologies in recent years has been notable; however, the provision of information feedback from the drone to the user is equally imperative for effective drone operation. Throughout the evolution of human-machine interaction design, continuous feedback and interaction from the machine to the operator have remained vital for managing challenging situations, as system errors are inevitable. In addition to basic visual feedback, research in conventional manned aircraft control systems suggests that providing feedback in additional dimensions, such as haptic feedback, to form a multimodal feedback system, has the potential to enhance control performance and facilitate accurate control decision-making. Presently, the majority of commercially available drones offer only visual feedback from a first-person perspective (FPV). However, the limited visibility may not provide adequate sensory information and could lead to delayed responses to changes in the flying environment. Furthermore, certain critical sensory perceptions, such as those provided by the human vestibular system, are essential for manned aircraft pilots to be aware of the aircraft's posture and motion. These sensory inputs are absent in drones due to their unmanned nature. Some researches aim to integrate tactile feedback or force feedback mechanisms in drone's control program to guide users and enhance control efficiency. However, challenges such as bulkiness, low resolution of the feedback units, and the need for fixed devices continue to impede the widespread adoption of feedback systems in drone control.

While visual feedback has been established as an effective means for the drone to aid in stable flight, it is limited in providing all-angle coverage. Even if the drone were capable of capturing visual signals from all angles, the constrained visual perspective of the human operator would still present challenges. This limitation becomes even more pronounced for drones compared to conventional fixed-wing aircraft, as drones possess the ability to fly in various directions, including left, right, and backward. During control, if the user raises their wrist, causing the drone to move backward due to the intuitive gesture control, the absence of rearward visual information from the drone may prevent the user from detecting obstacles positioned behind the drone. Consequently, continued backward movement of the drone could lead to a collision.

One potential solution is the adoption of stretchable electronics design, which diverges from traditional hard and rigid electronic boards. The high stretchability and epidermal characteristics of stretchable electronics render them ideal for applications requiring integration with the human body. Indeed, they have been widely used in biosignal monitoring, medical treatment, and human-machine interface domains. Moreover, certain researches have explored the application of stretchable electronics in drone operations. However, these studies primarily concentrate on drone control mechanisms, there are still unmet needs for integration of stretchable electronic feedback systems with drones to provide fast and precise responses to user gestures and enable intuitive drone control.

### SUMMARY OF THE INVENTION

To address abovesaid needs, the present invention provides an epidermal multimodal closed-loop system for human-drone interface, which enables intuitive drone control, mimicking the human vestibular system and meeting the demand for fast and precise responses to user gestures.

In accordance with one aspect of the present invention, provided is an epidermal multimodal human-drone interfacing system comprising: a base station configured to: receive hand orientation data of a user and obstacle data within a caution distance from a drone; and generate, on basis of a correlation of the hand orientation data and the obstacle data, respective control commands for providing tactile feedback to a user, stimulating multiple muscle groups of the user and controlling the drone; a drone control tactile feedback (DCTF) module in communication with the user and the base station, and configured to collect the hand orientation data of the user and deliver the tactile feedback to the user; and a neuromuscular electrical stimulation force feedback (NMESF) module in communication with the base station, the user and the drone, and configured to: collect the obstacle data within the caution distance from the drone and deliver stimulation current for stimulating the multiple muscle groups of the user.

Preferably, the base station is further configured to: receive video signals from a camera integrated in the drone; and transfer the real-time video signals to a virtual reality headset worn by the user to facilitate the user to set the hand orientation for drone control.

Preferably, the DCTF module includes a DCTF control unit and a tactile actuation module; the DCTF control unit is affixed to dorsum of the user's hand and configured to: collect the hand orientation data of the user, transmit the hand orientation data to the base station, receive an actuator control command from the base station, and convey the actuator control command to the tactile actuation module; and the tactile actuation module comprises a two-dimensional array of tactile actuators connected through an array of connectors, the array of tactile actuators being affixed on fingers of the user and configured to receive the actuator control command from the DCTF control unit and deliver the tactile feedback to the user's fingers.

Preferably, the DCTF control unit includes: an inertial measurement unit configured to collect the hand orientation data of the user; a first communication module configured to transmit the collected hand orientation data to the base station and receive the actuator control command from the base station; and a first microcontroller configured to generate actuator driving signals to drive the array of tactile actuators to deliver the tactile feedback to the user's fingers.

Preferably, each tactile actuator includes: a magnet; and a polyethylene terephthalate (PET) film having a cantilever structure to facilitate unrestricted movement of the magnet.

Preferably, the array of tactile actuators and the array of connectors are fabricated on a flexible and stretchable circuit board.

Preferably, the flexible and stretchable circuit board includes a stretchable substrate sandwiched between a pair of serpentine-patterned conductive layers.

Preferably, the NMESF module includes an obstacle detection unit and a NMESF control unit; the obstacle detection unit is positioned atop the drone and configured to collect the obstacle data within the caution distance from the drone and transmit the obstacle data to the base station; the NMESF control unit is attached on the user's arm and configured to receive stimulation command from the base station, and generate stimulation current to stimulate the multiple muscle groups of the user's arm.

Preferably, the obstacle detection unit includes: at least three laser detectors configured for detecting obstacle information in regions to the left, right, and rear of the drone respectively; a second microcontroller configured to process the detected obstacle information into obstacle data; and a second communication module configured to transmit the obstacle data to the base station for generating the stimulation command.

Preferably, the NMESF control unit includes: a third communication module configured to receive the stimulation command from the base station; a third microcontroller configured to generate control signals on basis of the stimulation command; a current driver configured to provide the simulation current; a switch configured to receive the control signals to switch on/off the current driver; and a plurality of stimulation electrodes attached on the user's arm and electrically coupled to the current driver to deliver the stimulation current to the multiple muscle groups of the user's arm.

Preferably, the plurality of stimulation electrodes is fabricated on a flexible and stretchable circuit board.

Preferably, the flexible and stretchable circuit board includes a stretchable substrate, a serpentine-patterned conductive layer and a stretchable and replaceable conductive hydrogel.

In accordance with a second aspect of the present invention, a method of using the epidermal multimodal human-drone interfacing system of the first aspect for facilizing a user to control a drone in an intuitive manner is provided.

The method comprises constituting a control-tactile feedback loop by: capturing, by the DCTF module, hand orientation data of the user; transmitting, by the DCTF module, the captured hand orientation data to the base station; converting, by the base station, the hand orientation data into drone control commands; transmitting, by the base station, the drone control commands to the drone; detecting, by the drone, flying angle and speed of the drone and transmitting the detected flying angle and speed to the base station; estimating, by the base station, flying posture and aerodynamic conditions of the drone; generating, by the base station, a two-dimensional tactile feedback map; generating, by the base station, actuator control commands based on the two-dimensional tactile feedback map; and transmitting, the actuator control commands to the DCTF module to induce tactile feedback to the user.

The method further comprises: constituting a force-control feedback loop by: collecting, by the NMESF module, obstacle data within the caution distance from the drone; transmitting, by the NMESF module, the obstacle data to the base station; translating, by the base station, the obstacle data into muscular stimulation commands and transmitting the muscular stimulation commands to the NMESF control unit mounted on user's forearm; and generating, by the NMESF control unit, force feedback stimulation to the user to influence the user's hand movement that in turn controls the drone through the DCTF module.

The method further comprises: constituting a visual feedback loop by: receiving real-time video signals from the camera integrated in the drone; and transmitting the video signals to the virtual reality headset of the user to facilitate the user to set the hand orientation for drone control.

The adoption of flexible and stretchable electronic design endows the system with a high degree of stretchability and wearability. Moreover, it eliminates bulky devices while integrating additional functionality with enhanced performance compared to previous attempts at human-drone interface development.

Moreover, the present invention can offer a straightforward means of drone control with reduced training periods and cognitive demand. Augmenting drone flight stability by enabling awareness of the surrounding flying environment and posture of drone. The incorporation of the force feedback loop mitigating the risk of accidental collisions, especial due to invisible obstacles, further enables drone operation in dynamic and intricate environments, such as urban or confined spaces. Moreover, the slim and skin-integrated design of the system maximizes wearability and enhances the comfort of drone control interactions.

### BRIEF DESCRIPTION OF THE DRAWINGS

Embodiments of the invention are described in more details hereinafter with reference to the drawings, in which:

FIG. 1 illustrates a block diagram of an epidermal multimodal human-drone interfacing system in accordance with one embodiment of the present invention.

FIG. 2A shows a block diagram of a DCTF module in accordance with one embodiment of the present invention; FIG. 2B shows a three-dimensional structural representation of the DCTF module. FIGS. 2C and 2D show front and back views of how the DCTF module is mounted on dorsum and fingers of user's hand respectively.

FIGS. 3A and 3B illustrate a three-dimensional structural representation and an optimal image of a DCTF control unit respectively in accordance with one embodiment.

FIG. 4A illustrates a three-dimensional structural representation of a close-up view of the connector; FIG. 4B illustrates a three-dimensional structural representation of a close-up view of the connector assembled with an actuator and a switch; FIG. 4C shows an optical image of two tactile actuators being connected by a connector; and FIG. 4D shows an optical image of an individual connector.

FIG. 5 illustrates a cross-sectional view of the double-layer stretchable circuit board for the tactile actuation module.

FIG. 6 illustrates a fabrication process of a stretchable circuit board for the tactile actuation module.

FIG. 7 illustrates configuration of an individual tactile actuator in accordance with one embodiment of the present invention.

FIG. 8 shows a pulse-width modulation signal used to control the vibration of the tactile actuator with different duty cycles.

FIG. 9 shows the operational principle of tactile feedback.

FIG. 10 illustrates the process of mapping of drone's angle data in virtual tactile feedback map.

FIG. 11 illustrates how the central point, along with the effective area, moves correspondingly as the drone undergoes angular variation.

FIG. 12A shows an original parabola decay function with a focus of 2.5; and FIG. 12B shows the central point, effective area and duty cycles of each actuator with the original decay function of FIG. 12A.

FIG. 13A shows a decay function after rotation of the drone; and FIG. 13B shows the central point, effective area and duty cycles of each actuator with the decay function of FIG. 13A.

FIG. 14A shows a decay function with a larger effective area, parabola decay function with a focus of 4.5; and FIG. 14B shows the central point, effective area and duty cycles of each actuator with the decay function of FIG. 14A.

FIG. 15A shows change of decay function to a linear decay; and FIG. 15B shows the central point, effective area and duty cycles of each actuator with the decay function of FIG. 15A.

FIG. 16A shows a block diagram of the NMESF control unit 310 in accordance with one embodiment of the present invention; and FIG. 16B illustrates how the NMESF control unit is mounted on a user's forearm.

FIGS. 17A and 17B illustrate a three-dimensional structural representation and an optimal image of a main circuit board of a NMESF control unit respectively in accordance with one embodiment.

FIGS. 18A and 18B illustrate a three-dimensional structural representation and an optimal image of a stimulation pad of a NMESF control unit respectively in accordance with one embodiment.

FIG. 19A shows a block diagram of the obstacle detection unit in accordance with one embodiment of the present invention and FIG. 19B illustrates how the obstacle detection unit 320 is positioned atop the drone.

FIG. 20 shows placement location of the stimulation electrodes for NMES force feedback.

FIG. 21 shows three rotational directions of the operator's hand induced by NMES.

FIG. 22A shows variable stimulation current output from the NMESF module; FIG. 22B shows stimulation current pulse with different duty cycles output from NMESF module; FIG. 22C shows the relationship between control voltage from DAC of NMESF control unit and the stimulation output current; FIG. 22D shows variable frequency output from the NMESF module.

FIGS. 23A to 23C illustrate relationship between stimulation current and torque in all three bending directions respectively.

FIG. 24 illustrates the equivalent circuit of the stimulation pathway of NMES.

FIG. 25 displays the average frequency response of the load, which includes two electrodes and the user's muscle, under electrical stimulation.

FIG. 26 illustrates relationship between stimulation frequency and generated torque on wrist flexion.

FIG. 27 illustrates impedance response of stimulation electrode under different voltage.

FIG. 28 illustrates the conceptual depiction of operational mechanism of how the present invention acts as an interface between a user and a drone.

FIGS. 29A and 29B show schematic diagram and flowchart for operational logic flow of how the system acts as an interface between a user and a drone.

FIG. 30 shows the performance of the drone's IMU is assessed, with the three-dimensional rotation planes-pitch, roll, and yaw.

FIG. 31 shows assessment results of the accuracy of the drone's IMU across all three axes.

FIG. 32 shows evaluation results of the long-term stability of the drone's IMU.

FIG. 33 shows the three axes of rotation of the user's hand.

FIG. 34 shows assessment results of the accuracy of the DCTF's IMU across all three axes.

FIG. 35 shows evaluation results of the long-term stability of the DCTF's IMU.

FIG. 36A shows amplitude of vibration of the tactile actuator under different frequency; and FIG. 36B shows amplitude of vibration of the tactile actuator under different duty cycles.

FIG. 37 illustrates response of the obstacle detection system when an obstacle is detected.

FIG. 38 shows results of accuracy test of the laser detector.

FIG. 39 demonstrates the system's ability to detect obstacles up to 2.5 meters away.

FIG. 40A illustrates how the tactile feedback system enhances the control stability of the drone; and FIG. 40B illustrates the ability of the obstacle detection unit to trigger muscle contraction through NMESF module.

FIG. 41 shows the communication protocol adopted by the epidermal multimodal human-drone interfacing system.

### DETAILED DESCRIPTION

In the following description, details of the present invention are set forth as preferred embodiments. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

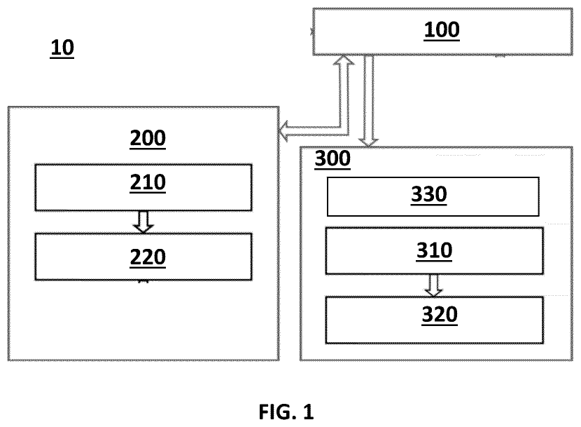

FIG. 1 illustrates a block diagram of an epidermal multimodal human-drone interfacing system 10 in accordance with one embodiment of the present invention. As shown, the system comprises: a base station 100 configured to: receive hand orientation data of a user and obstacle data within a caution distance from a drone; and generate, on basis of a correlation of the hand orientation data and the obstacle data, respective control commands for providing tactile feedback to a user's fingers, stimulating multiple muscle groups of the user's arm and controlling the drone; a drone control tactile feedback (DCTF) module 200 configured to: collect the hand orientation data of the user's hand and deliver the tactile feedback to the user's fingers; and a neuromuscular electrical stimulation force feedback (NMESF) module 300 configured to: collect obstacle data within the caution distance from the drone and deliver stimulation current to the multiple muscle groups of the user's arm.

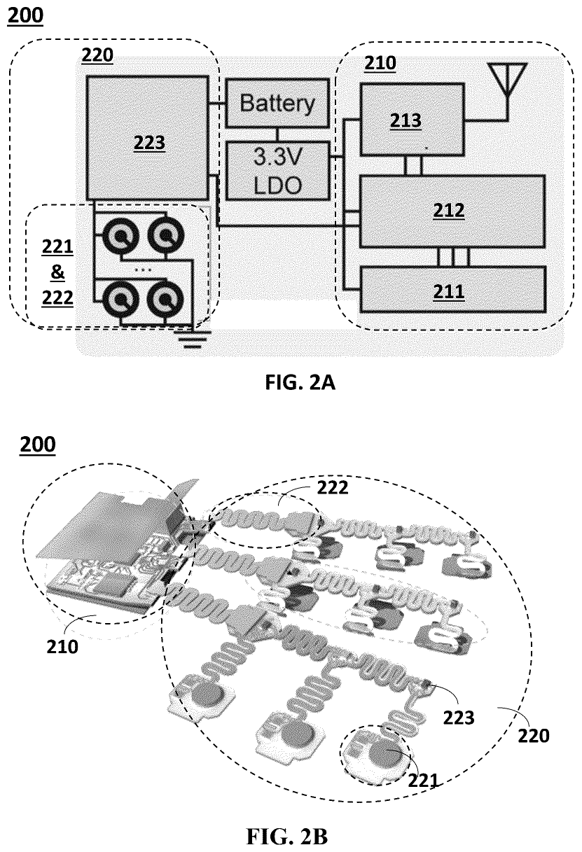

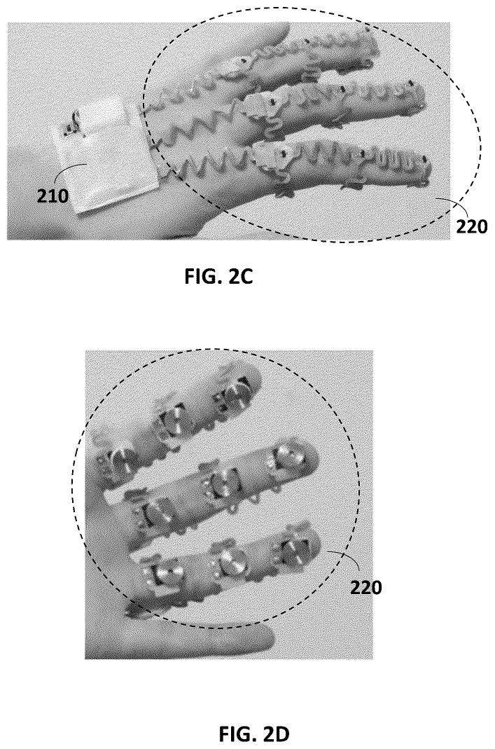

FIG. 2A shows a block diagram of a DCTF module 200 in accordance with one embodiment of the present invention. FIG. 2B illustrates a three-dimensional structural representation of the DCTF module; and FIGS. 2C and 2D show how the DCTF module is mounted on dorsum and fingers of user's hand.

The DCTF module 200 includes a DCTF control unit 210 to be affixed to the dorsum of the user's hand and a tactile actuation module 220 to be affixed to fingers of the user's hand.

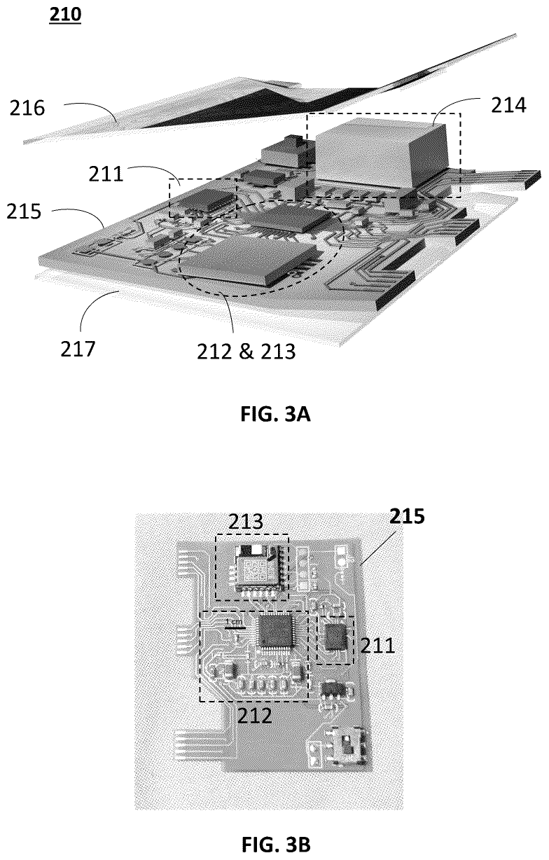

FIG. 3A illustrates a three-dimensional structural representation of the DCTF control unit and FIG. 3B shows an optical image of a DCTF control unit in accordance with one embodiment.

Referring to FIGS. 2A and 3A, the DCTF control unit 210 includes an IMU 211, a microcontroller (MCU) 212, wireless communication module 213 (e.g. a Bluetooth low energy (BLE) chip), and a battery 214. The IMU 211 is configured to monitor variations in the user's hand angle to collect orientation data. Orientation data is gathered by the MCU 212 and transmitted wirelessly via the wireless communication module 213. Additionally, the MCU 212 converts tactile feedback commands (or actuator control commands) received from the communication module 213 into digital output signals (or stimulation current signals), which are then conveyed to the tactile actuation module. In some embodiments, the DCTF control unit may be constructed from a flexible printed circuit board (FPCB) 215 and encased between a top silicon encapsulation film 216 and a bottom silicon encapsulation film 217.

The tactile actuation module 220 comprises a two-dimensional array (such as 3×3) of vibrational tactile actuators 221 connected through an array of connectors 222. The tactile actuation module 220 is further equipped with a plurality of switches 223 (such as a metal-oxide-semiconductor field-effect transistor (MOSFET)) coupled with the vibrational tactile actuators 221 via the connectors 222, capable of generating two-dimensional tactile feedback on the user's finger, which exhibits the highest sensitivity to tactile stimuli compare to all other body parts.

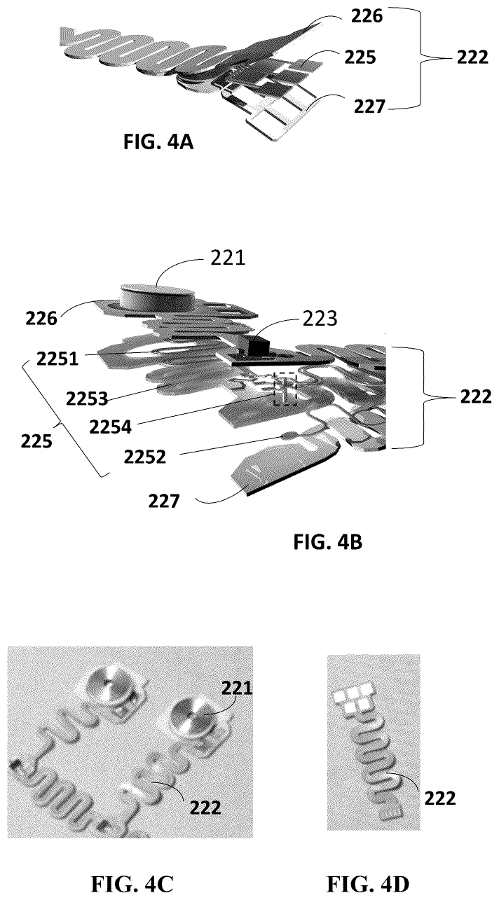

FIG. 4A illustrates a three-dimensional structural representation of a close-up view of the connector 222; FIG. 4B illustrates a three-dimensional structural representation of another close-up view of the connector 222 assembled with an actuator 221 and a switch 223; FIG. 4C shows an optical image of two tactile actuators being connected by a connector and FIG. 4D shows an optical image of an individual connector.

The connector 222 utilizes a thin (500 μm) and stretchable electronic design, featuring a serpentine FPCB layer 225 encased between a top silicon encapsulation film 226 and a bottom silicon encapsulation film 227, enable up to 50% stretching of device shape. This design accommodates both the flexion of the human finger and allows the device to be positioned close to the user's skin, enhancing comfort and user experience. The serpentine FPCB layer 225 may include an upper copper layer 2251 and a bottom copper layer 2252 and a dielectric layer 2253 sandwiched between the upper copper layer 2251 and the bottom copper layer 2252. The serpentine FPCB layer 225 may further include one or more copper vias 2254 passing through the dielectric layer 2253 and configured to electrically connect the upper copper layer 2251 and the bottom copper layer 2252.

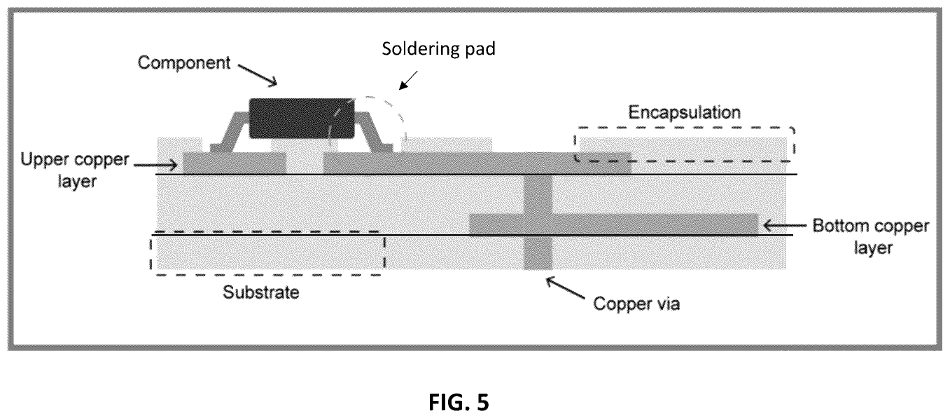

The stretchable electronic design adopts a multilayer structure aimed at reducing circuit dimensions and mitigating circuit wiring complexities. FIG. 5 illustrates a cross-sectional view of the double-layer stretchable circuit board for the tactile actuation module. As shown, the stretchable circuit board design comprises two layers of copper circuitry attached and separated by polydimethylsiloxane (PDMS) substrate and dielectric layer correspondingly. The connection between the two copper layers is established through vias and copper pins. Furthermore, the upper copper layer is encapsulated by PDMS, leaving only the soldering pad exposed. This arrangement facilitates the soldering of the integrated chip (IC) while ensuring the attachment of the copper layer during device deformation. Despite comprising only a single copper layer, the tactile actuation module also incorporates PDMS substrate and encapsulation to ensure its mechanical performance.

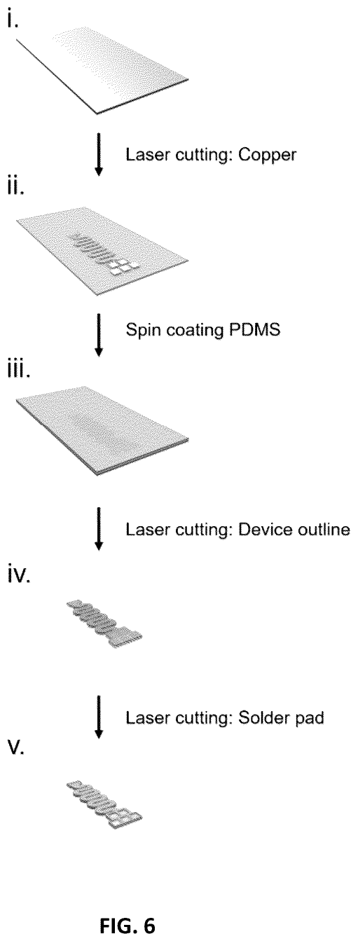

The fabrication process of the stretchable circuit board begins with the preparation of a piece of quartz glass (75 mm×75 mm), which is thoroughly cleaned with acetone, alcohol, and deionized water (DI water) to serve as the supporting layer. A sodium stearate aqueous solution is then spin-coated onto the glass and dried at 100° C. for 5 minutes, forming a thin sacrificial layer that facilitates the later removal of materials. Subsequently, 3.5 ml of a 20:1 mixture of PDMS and white silicone at a weight ratio of 1:310 is spin-coated onto the glass substrate at 500 rpm for 30 seconds. The coated substrate is then baked at 110° C. for 6 minutes, the spin coating and baking is repeated again with same parameter to form a 400 μm thin film of PDMS, which serves as the stretchable substrate for the device. Following this, a copper and polyimide (PI) film is affixed onto the PDMS film to form a multi-layered plate. Another baking step at 110° C. for 6 minutes is carried out to ensure strong adhesion between the copper and PI circuit layer and the PDMS substrate. Subsequently, the multi-layered plate undergoes laser cutting (FIG. 6). Initially, the laser cutter shapes the circuit, followed by the removal of excess copper and PI layers. After that, the multi-layered plate is spin-coated with 3.5 ml of a 20:1 PDMS substrate at 700 rpm for 30 seconds and baked at 110° C. for 12 minutes to create the encapsulation layer. The multi-layered plate will undergo laser cutting once more to outline the device and create soldering pads on the surface. For double-layer circuits, the vias are also cut using a laser cutter. The two layers are aligned and assembled with an ultrathin PDMS layer in between to create a strong adhesive bond between the layers. Vias are interconnected and soldered using copper pins with a diameter of 0.4 mm. MOSFET are soldered on the soldering pad using low-temperature soldering paste.

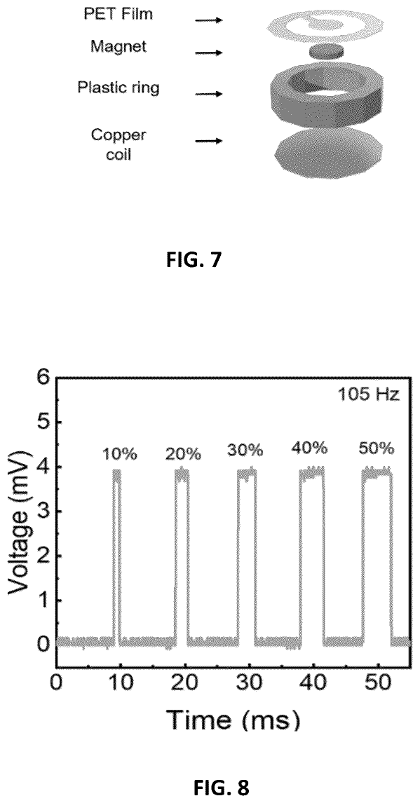

The configuration of an individual tactile actuator employed in the present invention is illustrated in FIG. 7. The tactile actuator may include a flexible thin-film, a magnet, a plastic ring and a copper coil. The flexible thin-film may have a cantilever structure to facilitate unrestricted movement of the magnet, while when a square wave signal with varying duty cycles (as shown in FIG. 8) is applied to the copper coil, inducing periodic upward and downward movement of the magnet is induced for generating vibrations. The flexible thin-film may be made of any suitable flexible materials, such as but not limited to, polyethylene terephthalate (PET), and polyimide.

FIG. 9 shows the operational principle of tactile feedback. As established in the previous section, the drone's angle during flight correlates with surrounding aerodynamic conditions. This angle variation is replicated on the 3×3 tactile actuator arrays affixed to the user's finger. When the drone tilts in a particular direction, the tactile feedback point also shifts from the center of the array towards the corresponding direction. This generates dynamic real-time tactile perception akin to a ‘rolling ball’ on the user's hand, enabling the user to perceive the aerodynamic conditions surrounding the drone.

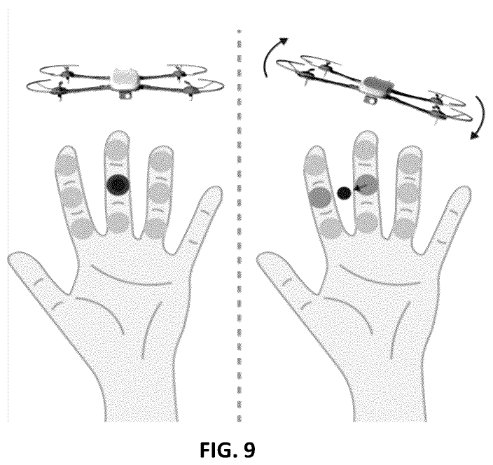

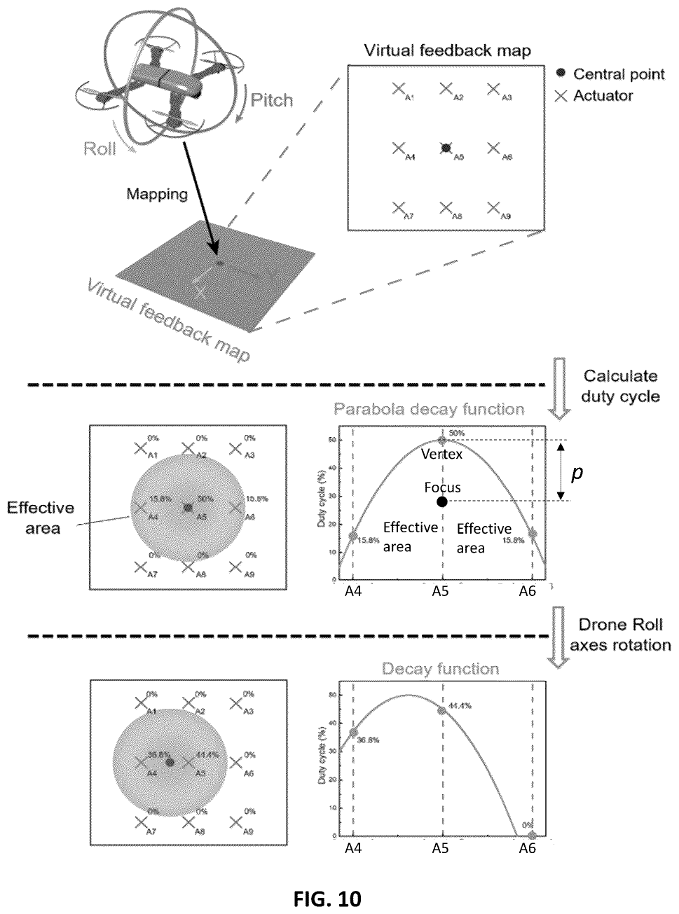

Referring to FIG. 10, in order to replicate the angular changes of the drone to the user through tactile feedback, the alterations in drone's roll and pitch axes angles are extracted and plotted onto a virtual two-dimensional map, generating a point designated as the “central point”. Variations in the drone's roll and pitch axes angles correspondingly change the X and Y coordinates of the central point on the map. Since the angular changes of the drone should be continuous and analog, monitoring multidimensional angular changes in the system may lead to a multitude of potential combinations for tactile stimulation locations, posing a challenge if one exact actuator is allocated to each coordinate. For instance, monitoring angle changes from positive to negative 10 degrees on both roll and pitch axes with one-degree accuracy could yield 22×22 possible coordinate combinations requiring replication by the tactile actuator array. This poses high demands on the density and resolution of the actuator array if each actuator represents only one coordinate on the map.

To regenerate informative spatial information on actuator arrays with lower resolution, a spatial down-sampling method is introduced. The distance (Δd) between each actuator and the central point is calculated and inputted into a decay function, The decay function can be selected from, but not limited to, parabolic, linear, and natural exponential decay functions. Then, the duty ratio (or duty cycle) of driving signal to each actuator is determined based on Δd. For example, for a parabolic decay function, the duty cycle may be obtained through the formula:

$$Duty cycle = \frac{Δ {d}^{2}}{- 2 p} ,$$

where p is the distance between the focus and vertex of the parabolic decay function. If the result (i.e. duty ratio) is positive, the corresponding actuator will be activated with the calculated duty cycle, while a negative result renders the actuator idle.

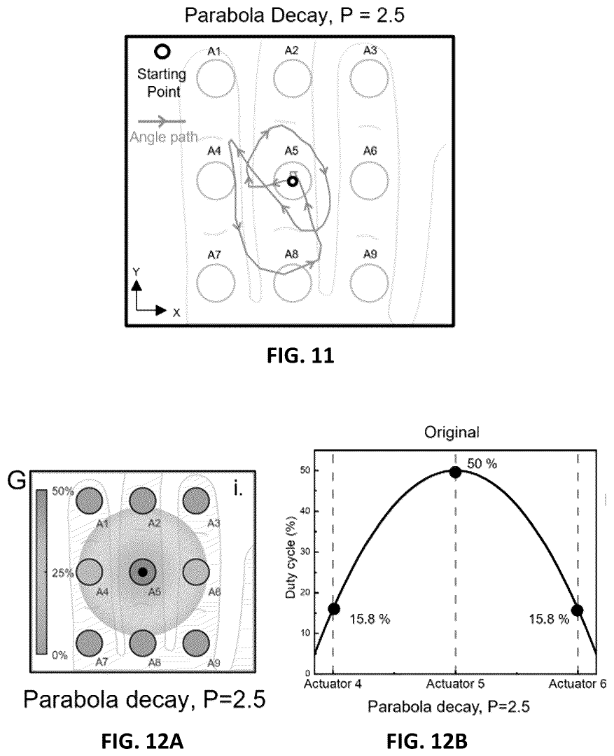

Employing the spatial down-sampling method, a circular area is delineated on the virtual feedback map surrounding the central point, where actuators are activated upon entering this area and stimulation intensity gradually increases until reaching maximum strength at the central point. This area is referred to as the “Effective area”. As the drone undergoes angular variation, the central point, along with the effective area, moves correspondingly (FIG. 11), altering the duty ratio of each actuator. Consequently, continuous angular variation is down-sampled and reproduced through changes in stimulation intensity of each actuator.

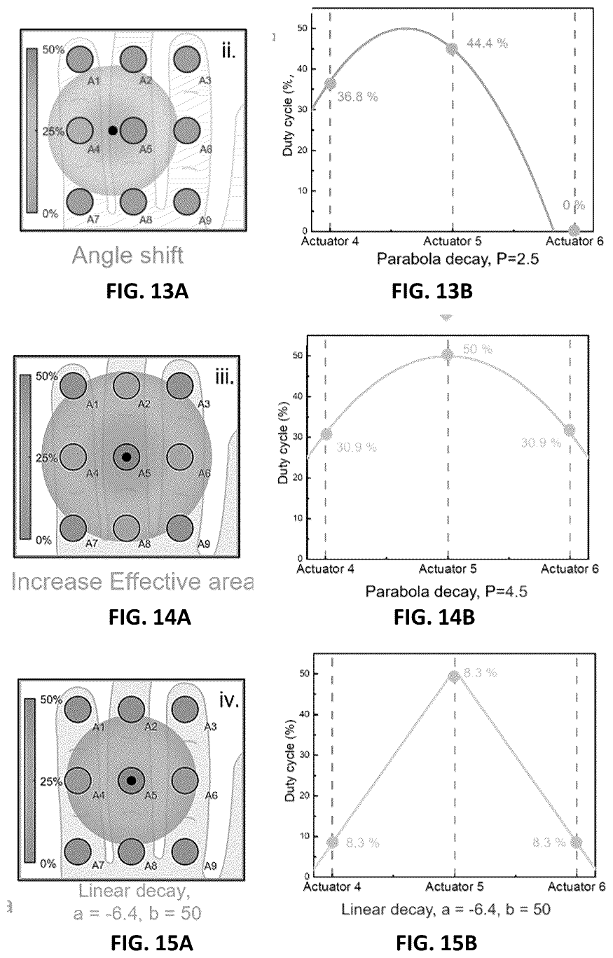

There are multiple parameters in the down-sampling method that can impact the tactile feedback experience and the efficiency of information transmission. For instance, starting with the original parabolic effective area (FIGS. 12A and 12B), the positioning of the area can shift in accordance with the angular variations of the drone (FIGS. 13A and 13B), and the size of the effective area can be expanded or reduced by adjusting parameters in the decay function (FIGS. 14A and 14B). Additionally, the decay function can be altered to generate different types of dynamic tactile feedback, such as transitioning from a parabolic function to a linear decay function (FIGS. 15A and 15B).

In one example implementation, the natural exponential decay function and effective area generated by a focus of 1.5 in the decay function are adopted due to their outstanding performance in the user study, and the user study confirms that the 3×3 tactile feedback arrays, along with the spatial down-sampling method, are capable of effectively transmitting two-dimensional spatial information to users for monitoring the drone's flight posture.

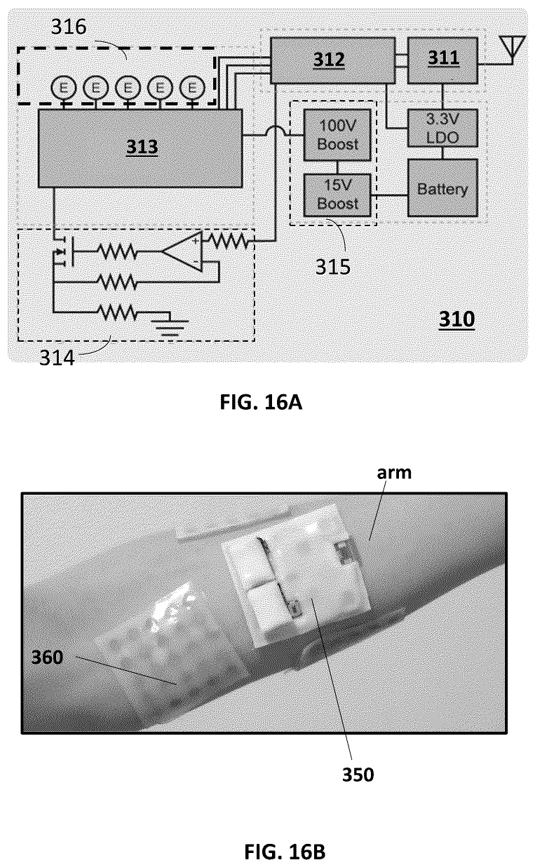

FIG. 16A shows a block diagram of the NMESF control unit 310 in accordance with one embodiment of the present invention.

The NMESF control unit 310 is configured to receive stimulation commands from the base station through a wireless communication module 311. The NMESF control unit may include an MCU 312, an analog switch 313 and a current driver 314 coordinated to deliver a specific amount of current to the targeted muscle. The NMESF control unit 310 may further include a two-stage boost circuit 315 configured to provide sufficient voltage to overcome the high impedance of the human body and deliver the required current. The current is then applied to the muscle through one or more arrays of stimulation electrodes 316. FIG. 16B illustrates how the NMESF control unit is mounted on a user's forearm. The wireless communication module 311, MCU 312, analog switch 313, current driver 314, the boost circuit 315 and a battery 317 may be assembled in a main circuit board 350 detachably mounted on the user's forearm. Each array of stimulation electrodes may be packaged as a stimulation pad 360 detachably mounted on the user's forearm.

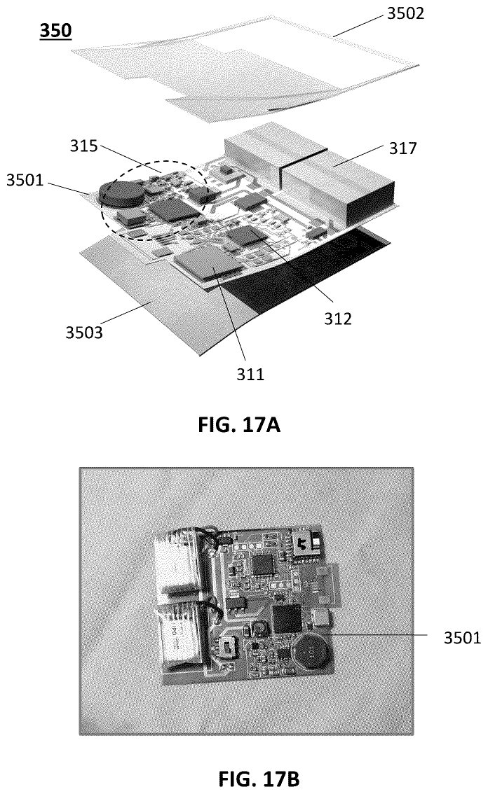

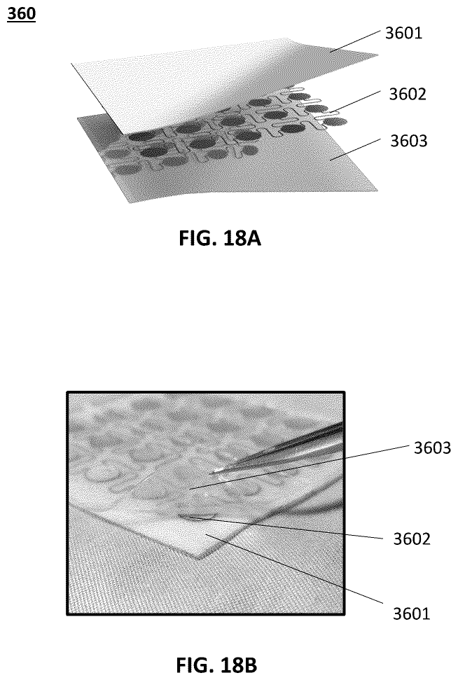

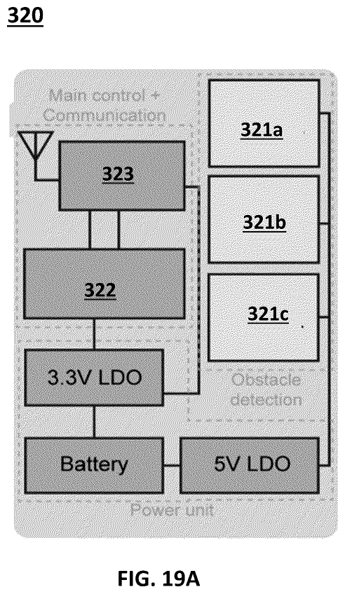

Referring to FIGS. 17A and 17B, similar to the DCTF control unit, the main circuit board 350 may also be constructed from a flexible printed circuit board (FPCB) 3501 and encased between a top silicon encapsulation film 3502 and a bottom silicon encapsulation film 3503. Referring to FIGS. 18A and 18B, the stimulation pad 360 also adopts a stretchable silicon substrate 3601 and serpentine copper layer 3602, allowing it to bend, flex, or stretch in various dimensions (FIGS. 18A and 18B). Additionally, a layer of stretchable and replaceable conductive hydrogel 3603 is affixed to each stimulation electrode to reduce the electrode-to-skin impedance.

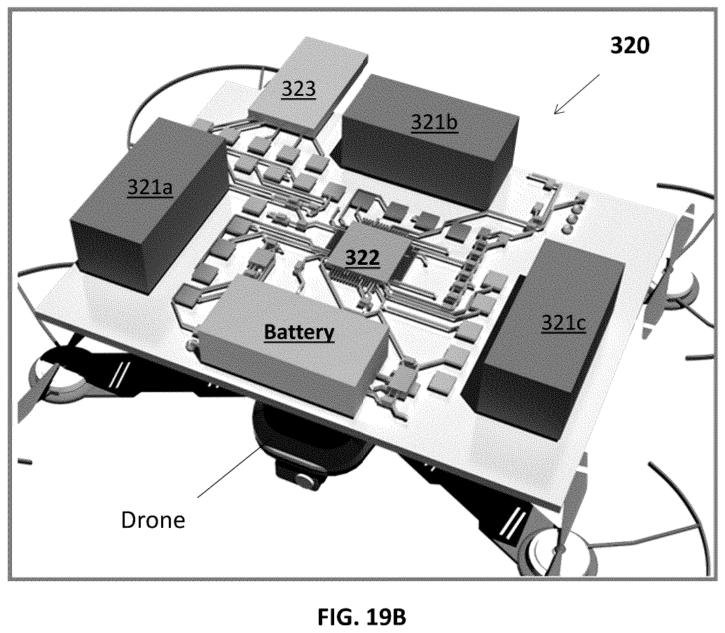

FIG. 19A shows a block diagram of the obstacle detection unit 320 in accordance with one embodiment of the present invention and FIG. 19B illustrates how the obstacle detection unit 320 is positioned atop the drone.

The obstacle detection unit may include three laser detectors (or sensors) 321a-321c configured for detecting obstacles in regions to the left, right, and rear of the drone-areas not covered by the drone camera. The obstacle information is processed by an MCU 322 into obstacle data and the obstacle data is wirelessly transmitted to the base station via a communication module 323 (e.g., a radio frequency (RF) module).

To mitigate the risk of collision, stimulation command is transmitted to the NMESF control unit upon detection of an obstacle by the obstacle detection unit within the system's caution distance. Leveraging the principle of NMES, electrical force feedback stimulation is delivered to the user's muscles (Flexor carpi ulnaris and Flexor carpi radialis) and inducing muscle contraction. As the drone approaches the obstacle, the intensity of stimulation gradually increases, causing stronger muscle contraction and wrist flexion in opposition to the upward motion of the wrist. This involuntary wrist flexion results in forward movement of the drone, counteracting the impending collision. The NMESF control unit is inactive and stimulation ceases when the drone moves beyond the caution distance. Thus, not only does the force feedback enable users to perceive invisible obstacles, but it also assists in course correction to avert potential collisions. Importantly, unlike traditional force feedback devices reliant on exoskeletons or bulky devices, the force in the NMESF control unit is generated originates from the user's muscles. Consequently, only thin electrodes and peripheral circuits are necessary, facilitating the miniaturization of the entire device to a size allow the wearing of device under everyday attire.

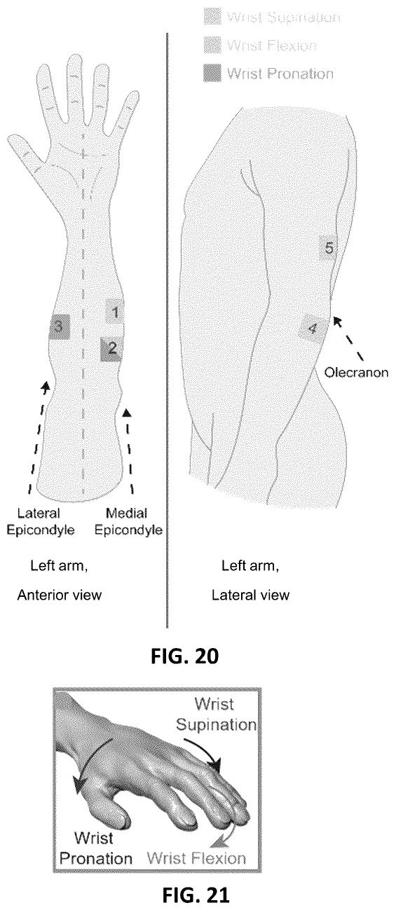

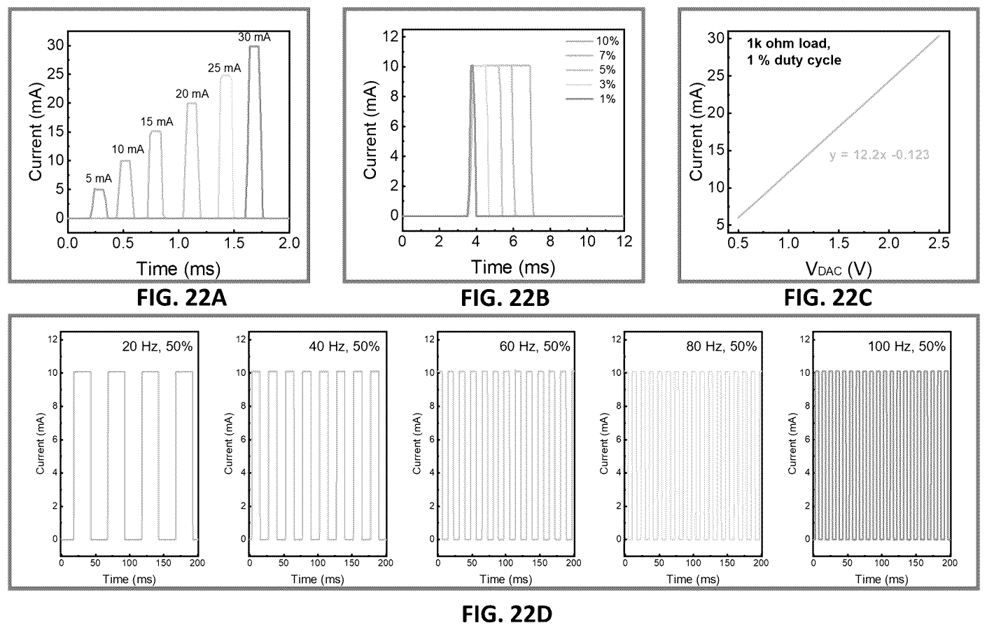

Three groups of muscles (Flexor carpi ulnaris and Flexor carpi radialis for flexion, Pronator teres for pronation, and Supinator for supination) will be stimulated by five electrodes, as depicted in FIG. 20, inducing contractions that produce rotation of the wrist in three directions: pronation, flexion, and supination (FIG. 21). These rotations occur along the roll and pitch axes of user's hand, which are utilized in intuitive drone control, and are capable of counteracting the left, right, and upward rotations of the user's wrist. Force feedback stimulation will be generated by the NMESF control unit in the form of electrical current pulses and the NMESF control unit is capable of delivering pulses with varying current levels (FIG. 22A), duty cycles (FIG. 22B), and frequencies (FIG. 22D) through the current control circuit by adjusting the digital-to-analog (DAC) output of the MCU. A straightforward control is established due to the linear relationship between the DAC output and the stimulation current output (FIG. 22C).

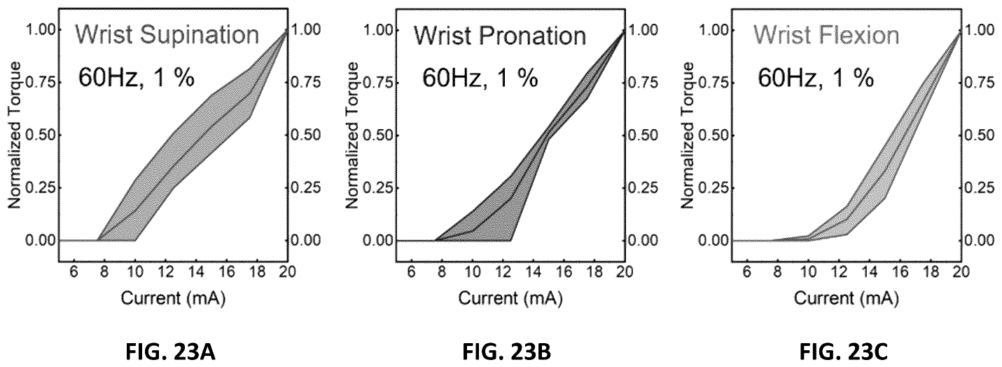

To assess the force generation capability of NMES on the user's muscles, torque tests were conducted, with results displayed in FIG. 23A to FIG. 23C. From the results, it is evident that although different users may exhibit different stimulation thresholds, the average torque generated during both supination, pronation, and flexion exhibits a proportional or even linear relationship with the stimulation current, demonstrating that the torque and force applied to the user's wrist by their own muscles can be accurately manipulated by adjusting the stimulation intensity. It is noteworthy that even the weakest wrist pronation can produce a torque around 0.4 Nm when high current is applied to the user's muscle, and this significant torque can induce involuntary wrist bending in the corresponding direction, aiding in path correction during flight.

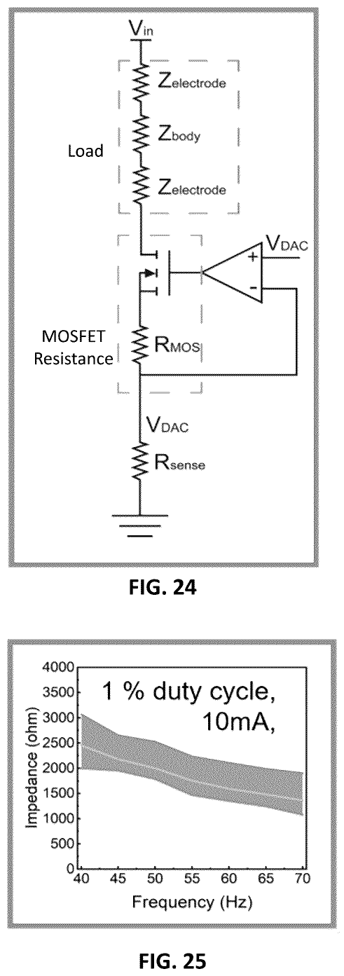

FIG. 24 illustrates the equivalent circuit of the stimulation pathway of NMES, where the load refers to the impedance of the user's muscle and the impedance of the electrodes. The MOSFET resistance (R_{ds(on)}) is controlled by the operational amplifier (OP-AMP) and the DAC output from the MCU to ensure that the current flow through the electrode and body matches the target current. According to the equivalent circuit, it is evident that if the load impedance is high, a higher input voltage generated by the voltage boost circuit (Vᵢₙ) will be required base on Ohm's law. Therefore, the electrical characteristics of the electrodes and the user's body become critical factors in reducing the requirement on the voltage boost circuit. One possible solution is to increase the stimulation frequency.

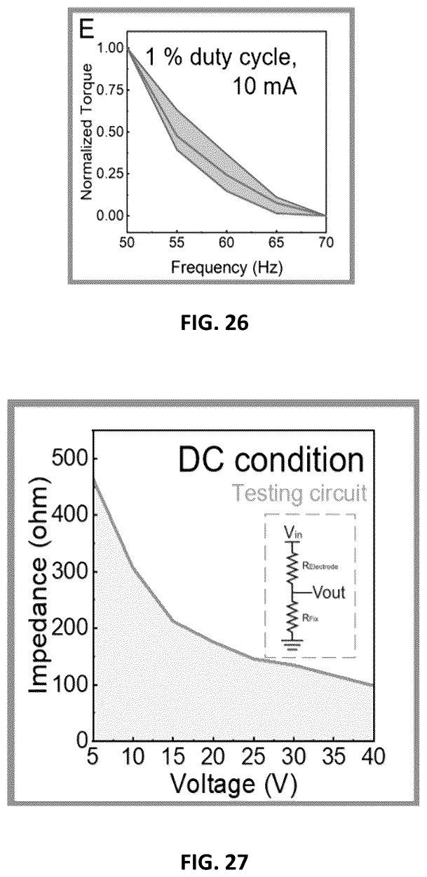

FIG. 25 displays the average frequency response of the load, which includes two electrodes and the user's muscle, under electrical stimulation. A noticeable decrease in average impedance from 2450Ω to 1360Ω is observed as the stimulation frequency increases from 40 Hz to 70 Hz. This may be attributed to the same decreasing trend in the frequency response of the electrode as the frequency increases, and human body impedance may also exhibit a declining response to the increasing frequency. However, testing indicates that the torque generated by the user also decreases with the increasing frequency (FIG. 26).

To balance the impedance of the stimulation path and the generated torque, we selected 60 Hz as the final stimulation frequency. While the system demonstrates the capability to generate current pulses with diverse duty cycles, users have reported experiencing discomfort as the duty cycle increases. Consequently, the duty cycle is maintained at 1% throughout stimulation to mitigate any discomfort for the user.

Despite optimizing the impedance of the stimulation pathway by adjusting the stimulation frequency, a high voltage remains necessary to overcome the 1.6 kΩ average impedance of the load at 60 Hz. Additionally, the relationship between excitation voltage and the impedance of the electrode (FIG. 27) indicates that a higher stimulation voltage can further decrease the impedance of the electrode. This finding led to the design of a two-stage voltage boost circuit in the NMESF module. The boost circuit is designed to elevate the input of 7.4 V from batteries to an output of 100 V for electric stimulation.

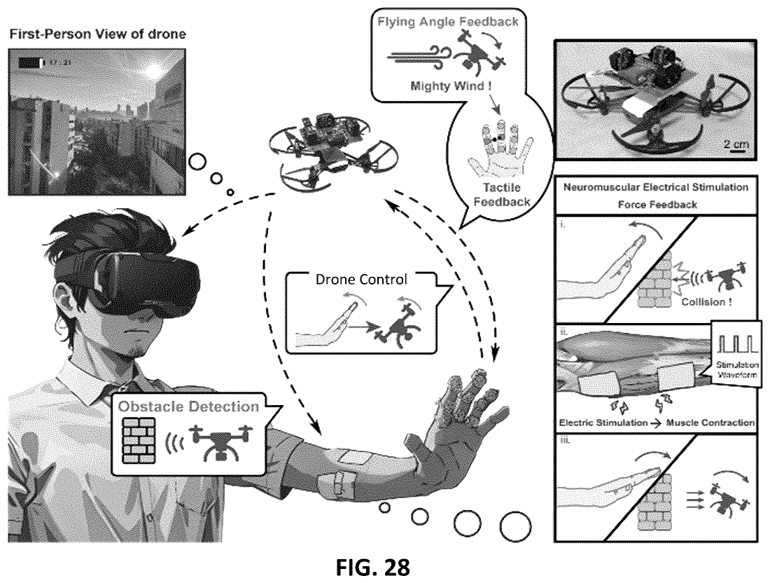

FIG. 28 illustrates the conceptual depiction of operational mechanism of how the present invention acts as an interface between a user and a drone. The present invention integrates four primary functionalities: 1) receive FPV visual feedback provided by the drone; 2) intuitive drone control through hand gestures of the user; 3) tactile feedback mimicking human vestibular system, offering real-time flight angle or posture information to allow dynamic monitoring of the flying and aerodynamic conditions surrounding the drone; and 4) delivery of electrical stimulation to the user's muscles, resulting in muscle contraction and the generation of tension and force as a form of force feedback counteracting or reversing hand motion upon detection of obstacles in the corresponding direction, aimed at mitigating the risk of potential collisions and accidents.

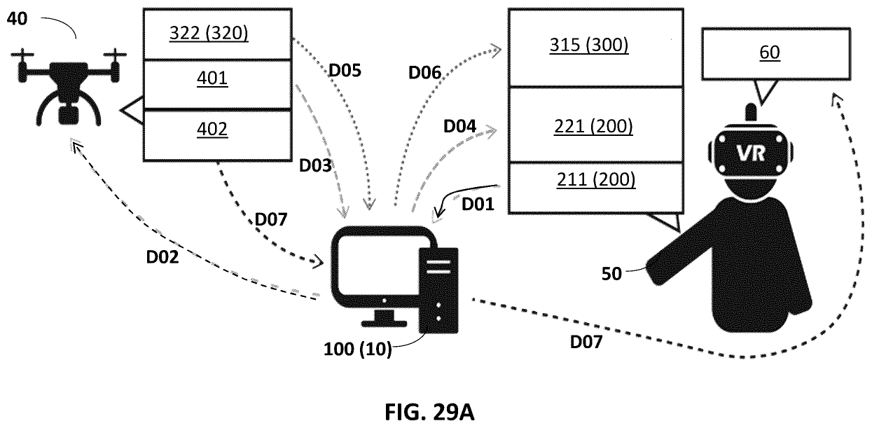

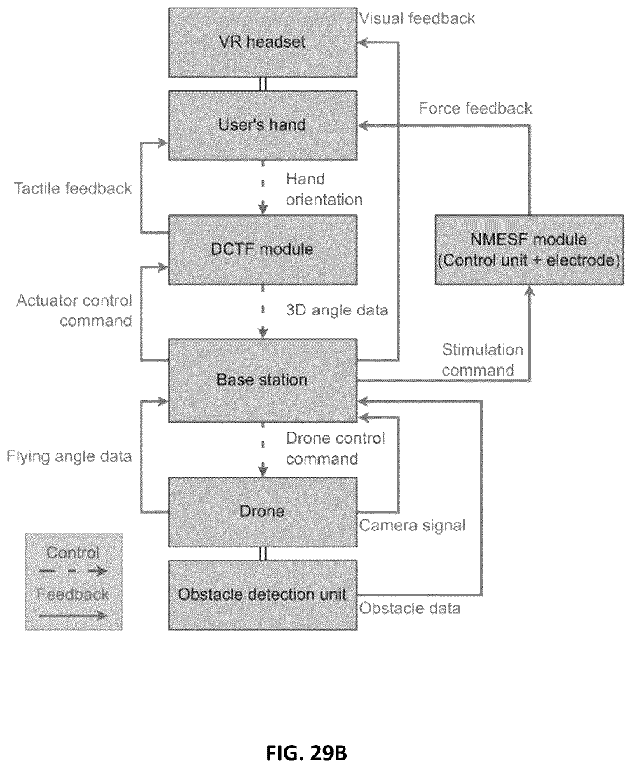

The operational logic flow of how the system 10 acts as an interface between a user 50 and a drone 40 is delineated in FIGS. 29A and 29B. The operation starts with the capture of hand orientation data by the IMU 211 of the DCTF module 200. The hand orientation data D01, gathered by the DCTF module, is wirelessly transmitted to the base station 100 (e.g. a computer) of the system 10. Subsequently, the base station 100 converts the hand orientation (or angle) data D01 into drone control commands D02 and transmits the drone control commands D02 to the drone 40 via a wireless local area network (WLAN), thereby directing the drone's movement according to hand gestures. The flying angle and speed D03 of the drone are detected by an IMU 401 of the drone 40 and transmitted back to the base station 100 for estimation of flying posture and aerodynamic conditions. The estimated flying posture and aerodynamic conditions are utilized to generate a two-dimensional tactile feedback map, and actuator control commands D04 are transmitted back to the DCTF module 200 to induce tactile feedback on the user's finger via the actuators 221. The tactile feedback, coupled with intuitive control facilitated by hand gestures, constitutes the control-tactile feedback loop.

In addition to tactile feedback, the laser sensors 321 of the obstacle detection unit 320 mounted on the drone detects obstacle presence and distance from the drone and converts the detected obstacle presence and distance to obstacle data D05. The obstacle data D05 is transmitted to the base station 100 via the RF module and translated by the base station 100 into muscular stimulation commands D06. These stimulation commands D06 are transmitted via BLE to the NMESF control unit 310, which generates electrical stimulation through the stimulation electrodes 315 to provide force feedback that influence the user's hand movement. As the drone 40 is controlled by hand movements, the NMES force feedback and intuitive control form the force-control feedback loop.

Moreover, the integrated camera 402 on the drone 40 sends real-time video signals D07 back to the base station 100 via WLAN. The base station subsequently transfers the signals D07 wirelessly to a Virtual Reality (VR) headset 60, forming the visual feedback loop. Together with intuitive control, tactile feedback, and force feedback, these loops comprise the multimodal closed-loop control system.

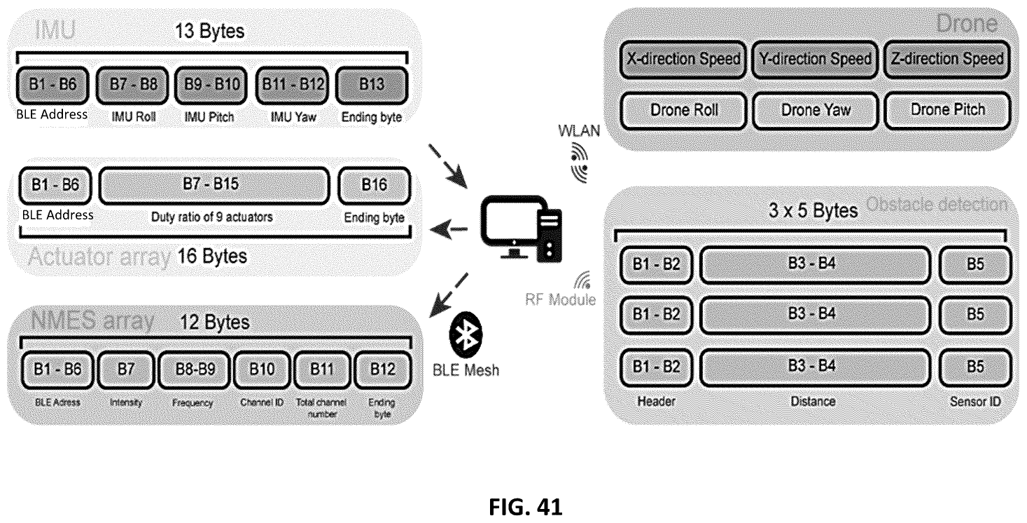

The communication protocol is shown in FIG. 41. IMU data from DCTF module is sent to base station via Bluetooth mesh with 13 bytes information including roll, pitch and yaw angle. Base station translates the IMU data into three-dimensional control command and delivers to drone using WLAN, the roll, pitch and yaw angle data of drone is sent back to base station, translated into actuator command based on decay function, packed into a 16 bytes data, contain duty ratio of each actuator, and send back to DCTF module using Bluetooth mesh. The obstacle detection unit sends 5 bytes message to base station containing the distance between obstacle and identity number of the sensor using radio frequency. Base station translates the message into electrical stimulation command and delivers the command to NMESF module with a 12 bytes message containing current, frequency and targeted channel by Bluetooth mesh.

The DCTF control unit and NMESF control unit are based on FPCB, microcontroller, Bluetooth module, low-dropout regulator, resistor and capacitor are adopted by both DCTF control unit and NMESF control unit. DCTF control unit integrated inertial measurement unit. NMESF control unit including analog switch, operational amplifier, MOSFET, and boost circuit controllers. All components are soldered on the FPCB using low-temperature soldering paste. The obstacle detection unit mounted on the drone is based on PCB, including microcontroller, low-dropout regulators, three Laser detectors, RF communication module, resistor and capacitor. All component also soldered using low-temperature soldering paste.

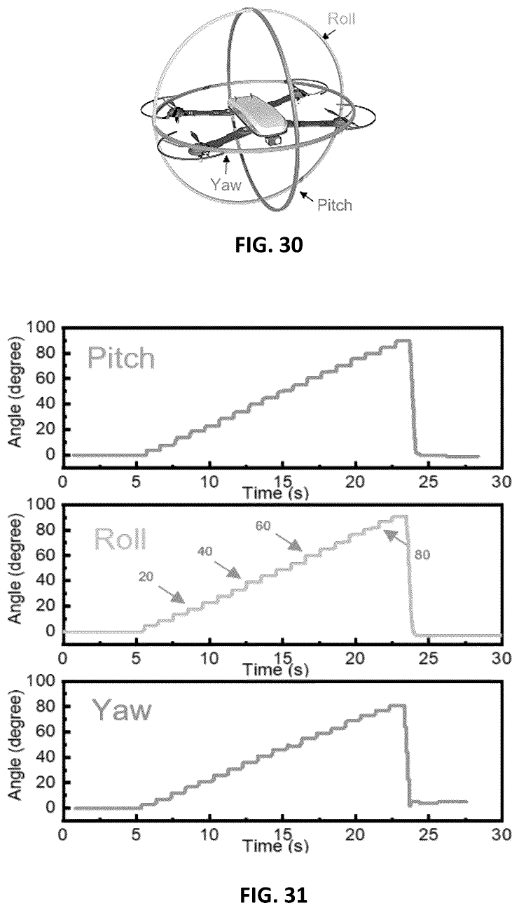

The performance of the drone's IMU is assessed, with the three-dimensional rotation planes—pitch, roll, and yaw—depicted in FIG. 30. Real-time rotational information of the drone across these three planes is recorded during flight. The accuracy of the drone's integrated IMU in the three-dimensional rotation planes-pitch, roll, and yaw are evaluated in FIG. 31). During testing, the drone undergoes rotation from 0 degrees to 90 degrees in 5-degree increments on a robotic arm. The angle readings from the drone for the pitch, roll, and yaw dimensions consistently align with the test settings, demonstrating the high accuracy of the drone's IMU and its ability to capture minute variations in drone angle during flight.

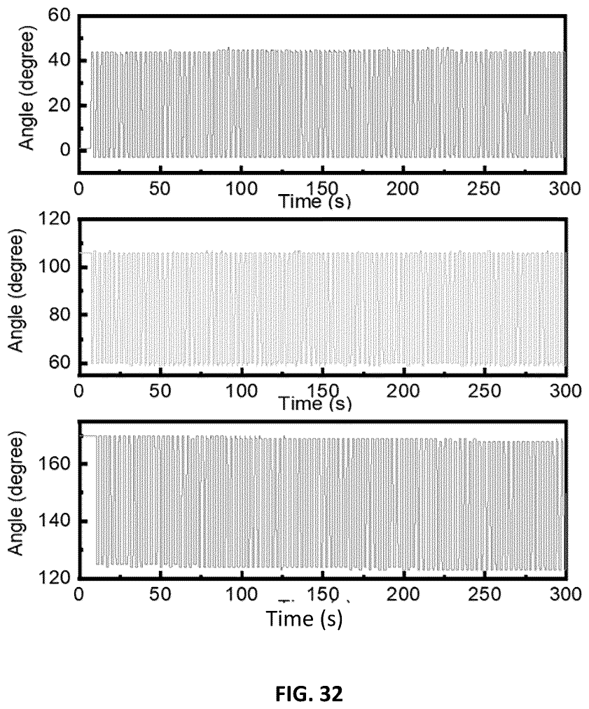

Furthermore, a long-term test is conducted wherein the robotic arm, affixed with the drone, is continuously rotated 45 degrees for 300 seconds. The test duration is limited to 300 seconds as the drone system automatically shuts down after this period if no control command is issued. The results across all three dimensions (FIG. 32) exhibit high repeatability, with a consistent 45-degree variation observed during the testing period. Only the yaw direction demonstrates a minor shift of 2 to 3 degrees, attributed to the magnetic compass utilized in the 9-axis IMU, which is inherently susceptible to shifting or interference from surrounding magnetic anomaly field when compare to pitch and roll axis. The high repeatability and stability, coupled with the high accuracy, affirm that the drone's integrated IMU can provide reliable angular data during flight.

Following the evaluation of the drone's IMU performance, an examination of the relationship between drone angles during flight and surrounding wind speed and direction is undertaken. Analogous to other aircraft, drone flight can be significantly influenced by aerodynamic conditions such as wind speed and direction. Operators may require immediate adjustments to correct flight posture and heading direction upon encountering strong winds, especially considering that airflow is imperceptible in visual feedback. While some sensors are capable of monitoring these aerodynamic factors directly, the incorporation of additional sensors, particularly when drones are subjected to multidirectional winds or turbulence, results in increased size and weight, imposing a significant burden on the drone. Analysis of the correlation between unexpected variations in drone flight angle and sudden changes in external aerodynamic conditions reveals that, with increasing wind speed, the pitch and roll axes experience augmented variations in drone angle, with the most significant angle variation occurring at a wind speed of 8.76 m/s. This proportional relationship underscores that changes in drone angle during flight can reflect dramatic alterations in aerodynamic conditions. To address this challenge, drone angular data is transmitted back to the base station for aerodynamic situation estimation in the present invention.

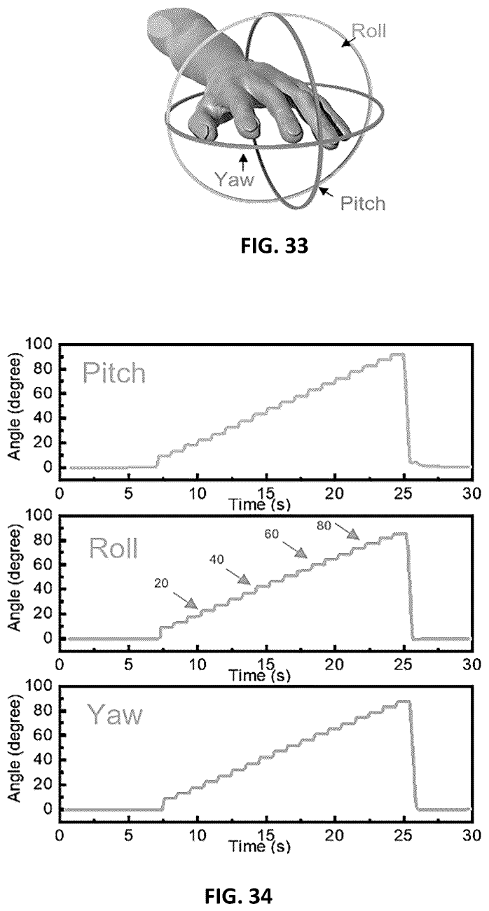

Given the system's reliance on the orientation of the user's hand as an intuitive means of drone control, the performance of the IMU within the DCTF module has critical importance in ensuring control quality. The three axes of rotation of the user's hand are depicted in FIG. 33, the pitch, roll, and yaw, which correspond to those of the drone. Rotation of the user's hand will induce similar movements in the drone. For instance, after the calibration process that records the initial orientation of the user's hand, if user rotates their hand downward along the pitch axis, the drone will likewise rotate in the pitch axis and causing the drone to fly forward. In the event that rotations on multiple axes of the user's hand are detected (e.g., rotations on both the pitch and yaw axes), the drone will respond by flying with multiple vectors (e.g., forward and left). Moreover, a larger rotation detected by the DCTF module prompts the drone to fly in the corresponding direction at a higher speed. Thus, the DCTF module must be capable of accurately and reliably capturing angular variations in the user's hand. FIG. 34 displays the accuracy testing results of the DCTF module, the test is similar to that conducted on the drone, result showing a significant 5-degree increment and a total 90-degree rotation observed for all three rotation axes.

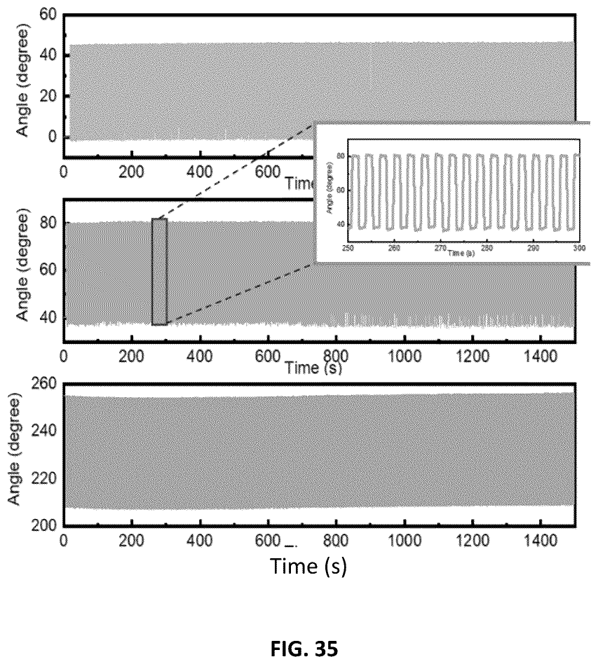

The 25-minute long-term test results for the DCTF module (FIG. 35), exhibiting a consistent 45-degree variation, underscore the high repeatability of the DCTF system on angle monitoring. Similar to the drone's IMU system, the DCTF module also demonstrate high accuracy and repeatability, rendering them suitable for precise drone control.

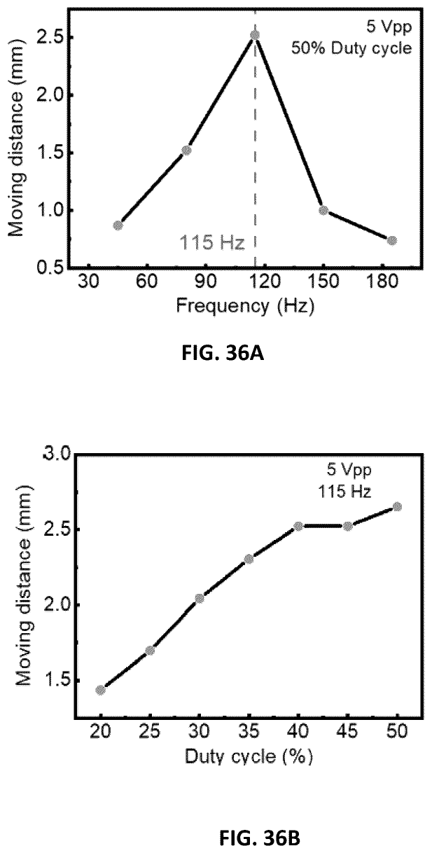

The resonant frequency of the actuator is examined (FIG. 36A), with vibration amplitudes compared across frequencies ranging from 45 Hz to 185 Hz at intervals of 35 Hz. The results indicate that the actuator attains maximum vibration amplitude at 115 Hz, which is adopted in the present invention and considered the resonant frequency of the actuator. Additionally, the impact of duty cycle on vibration amplitude is investigated. Duty cycles ranging from 20% to 50% are applied to the actuator, revealing a strong proportional relationship between duty cycle and vibrational amplitude (FIG. 36B). This suggests that higher duty cycles result in greater vibration intensity. However, the maximum duty cycle adopted in the present invention is limited to 50%. This is because base on the principle of actuator, a longer duty cycle, such as 70%, yields similar performance to a lower duty cycle, such as 30%, while also have a prolonged ‘turn on’ time and increased power consumption.

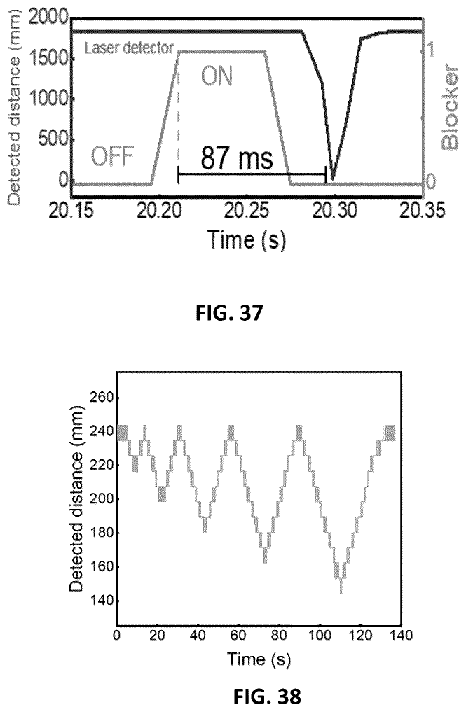

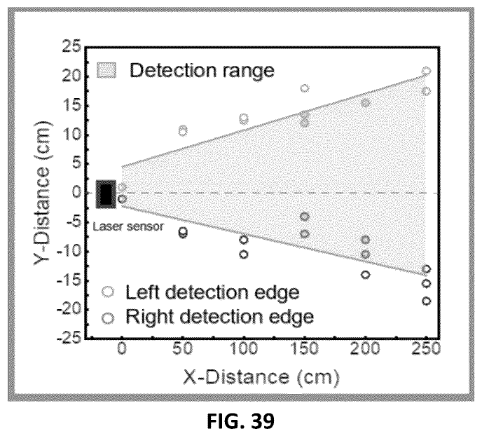

Furthermore, the performance of the obstacle detection unit is evaluated. FIG. 37 demonstrates that the unit can detect obstacles with a short response time of 87 ms, which is feasible for scenarios involving drones or obstacles moving at high speeds and requiring rapid reactions. FIG. 38 illustrates the accuracy of the laser detectors in the unit in detecting obstacles at different distances, while FIG. 39 demonstrates the system's ability to detect obstacles up to 2.5 meters away. And the median detection range enables the system to effectively detect obstacles without interference from obstacles in other directions.

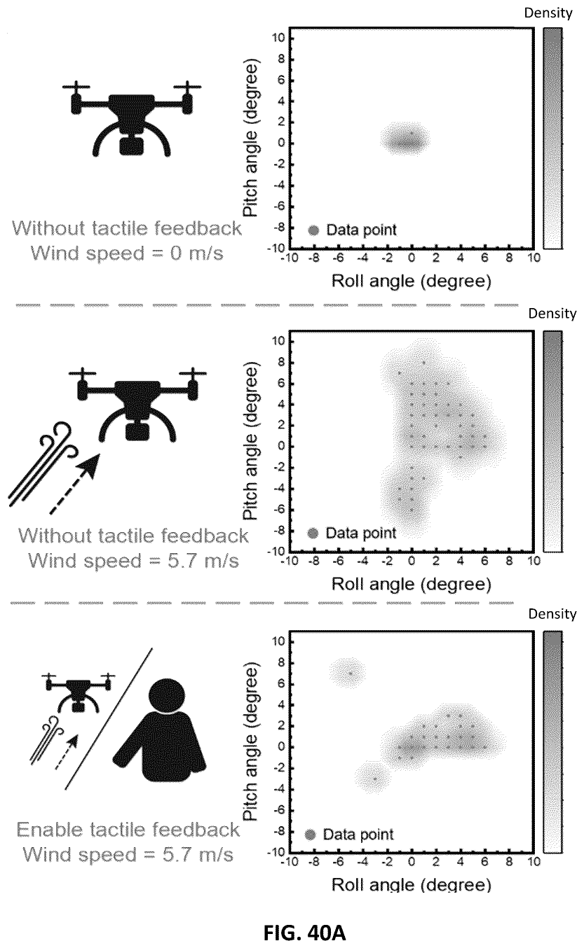

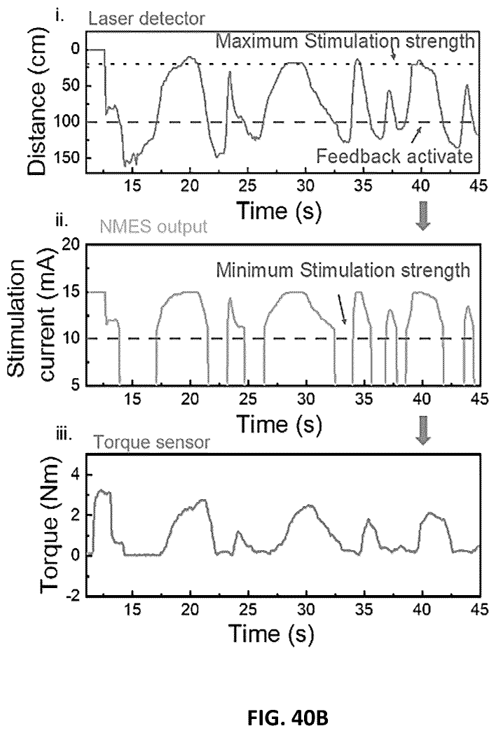

In FIGS. 40A and 40B, the performance of the multimodal closed-loop human-drone interface system is demonstrated in an actual flying scenario. FIG. 40A illustrates how the tactile feedback system enhances the control stability of the drone. It displays the angular variation of the drone under windy conditions with and without the tactile feedback system. The X and Y axes represent the roll and pitch rotation of the drone, respectively, while the depth of color indicates the density of data points. Under windless conditions, the drone remains stable with a variation of 1 to 2 degrees. However, when subjected to a wind speed of 5.7 m/s, the angular variation rapidly increases. Upon activating the tactile feedback system, users are able to perceive the abnormal changes in the drone's posture and counteract the wind, resulting in lower angle changes and a more stable flight. This demonstrates that the tactile feedback system can enhance the flying stability of the drone under complex aerodynamic conditions.

The ability of the obstacle detection unit to trigger muscle contraction through NMESF module is validated in FIG. 40B. The system is configured to activate stimulation when an obstacle is detected within 1 meter. Stimulation strength gradually increases as the obstacle approaches, reaching maximum strength at 20 cm. The data indicates a consistent correlation between obstacle distance, stimulation current, and torque generated by the muscle, confirming the NMESF control unit's capability to contract user muscles upon obstacle detection.

The functional units and modules of the epidermal multimodal human-drone interfacing system in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

While the present disclosure has been described and illustrated with reference to specific embodiments thereof, these descriptions and illustrations are not limiting. The illustrations may not necessarily be drawn to scale. There may be distinctions between the artistic renditions in the present disclosure and the actual apparatus due to manufacturing processes and tolerances. There may be other embodiments of the present disclosure which are not specifically illustrated. Modifications may be made to adapt a particular situation, material, composition of matter, method, or process to the objective and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations.

What is claimed is:

1. An epidermal multimodal human-drone interfacing system, comprising:
a base station configured to:
receive hand orientation data of a user and obstacle data within a caution distance from a drone; and
generate, on basis of a correlation of the hand orientation data and the obstacle data, respective control commands for providing tactile feedback to a user, stimulating multiple muscle groups of the user and controlling the drone;
a drone control tactile feedback (DCTF) module in communication with the user and the base station, and configured to collect the hand orientation data of the user and deliver the tactile feedback to the user; and
a neuromuscular electrical stimulation force feedback (NMESF) module in communication with the base station, the user and the drone, and configured to: collect the obstacle data within the caution distance from the drone and deliver stimulation current for stimulating the multiple muscle groups of the user.

2. The epidermal multimodal human-drone interfacing system according to claim 1, wherein the base station is further configured to:
receive real-time video signals from a camera integrated in the drone; and
transfer the real-time video signals to a virtual reality headset worn by the user to facilitate the user to set the hand orientation for drone control.

3. The epidermal multimodal human-drone interfacing system according to claim 1, wherein:
the DCTF module includes a DCTF control unit and a tactile actuation module;
the DCTF control unit is affixed to dorsum of the user's hand and configured to: collect the hand orientation data of the user, transmit the hand orientation data to the base station, receive an actuator control command from the base station, and convey the actuator control command to the tactile actuation module; and
the tactile actuation module comprises a two-dimensional array of tactile actuators connected through an array of connectors, the array of tactile actuators being affixed on fingers of the user and configured to receive the actuator control command from the DCTF control unit and deliver the tactile feedback to the user's fingers.

4. The epidermal multimodal human-drone interfacing system according to claim 3, wherein the DCTF control unit includes:
an inertial measurement unit configured to collect the hand orientation data of the user;
a first communication module configured to transmit the collected hand orientation data to the base station and receive the actuator control command from the base station; and
a first microcontroller configured to generate actuator driving signals to drive the array of tactile actuators to deliver the tactile feedback to the user's fingers.

5. The epidermal multimodal human-drone interfacing system according to claim 3, wherein each of the tactile actuators includes:
a magnet; and
a polyethylene terephthalate (PET) film having a cantilever structure to facilitate unrestricted movement of the magnet.

6. The epidermal multimodal human-drone interfacing system according to claim 5, wherein the array of tactile actuators and the array of connectors are fabricated on a flexible and stretchable circuit board.

7. The epidermal multimodal human-drone interfacing system according to claim 6, wherein the flexible and stretchable circuit board includes a stretchable substrate sandwiched between a pair of serpentine-patterned conductive layers.

8. The epidermal multimodal human-drone interfacing system according to claim 1, wherein:
the NMESF module includes an obstacle detection unit and a NMESF control unit;
the obstacle detection unit is positioned atop the drone and configured to collect the obstacle data within the caution distance from the drone and transmit the obstacle data to the base station; and
the NMESF control unit is attached on the user's arm and configured to receive stimulation command from the base station, and generate stimulation current to stimulate the multiple muscle groups of the user's arm.

9. The epidermal multimodal human-drone interfacing system according to claim 8, wherein the obstacle detection unit includes:
at least three laser detectors configured for detecting obstacle information in regions to the left, right, and rear of the drone respectively;
a second microcontroller configured to process the detected obstacle information into obstacle data; and
a second communication module configured to transmit the obstacle data to the base station for generating the stimulation command.

10. The epidermal multimodal human-drone interfacing system according to claim 8, wherein the NMESF control unit includes:
a third communication module configured to receive the stimulation command from the base station;
a third microcontroller configured to generate control signals on basis of the stimulation command;
a current driver configured to provide the simulation current;
a switch configured to receive the control signals to switch on/off the current driver; and
a plurality of stimulation electrodes attached on the user's arm and electrically coupled to the current driver to deliver the stimulation current to the multiple muscle groups of the user's arm.

11. The epidermal multimodal human-drone interfacing system according to claim 10, wherein the plurality of stimulation electrodes is fabricated on a flexible and stretchable circuit board.

12. The epidermal multimodal human-drone interfacing system according to claim 11, wherein the flexible and stretchable circuit board includes a stretchable substrate, a serpentine-patterned conductive layer, and stretchable and replaceable conductive hydrogel.

13. A method of using the epidermal multimodal human-drone interfacing system of claim 1 for facilizing a user to control a drone in an intuitive manner, the method comprises constituting a control-tactile feedback loop by:
capturing, by the DCTF module, hand orientation data of the user;
transmitting, by the DCTF module, the captured hand orientation data to the base station;
converting, by the base station, the hand orientation data into drone control commands;
transmitting, by the base station, the drone control commands to the drone;
detecting, by the drone, flying angle and speed of the drone and transmitting the detected flying angle and speed to the base station;
estimating, by the base station, flying posture and aerodynamic conditions of the drone;
generating, by the base station, a two-dimensional tactile feedback map;
generating, by the base station, actuator control commands based on the two-dimensional tactile feedback map; and
transmitting, the actuator control commands to the DCTF module to induce tactile feedback to the user.

14. The method of claim 13, further comprising constituting a force-control feedback loop by:
collecting, by the NMESF module, obstacle data within the caution distance from the drone;
transmitting, by the NMESF module, the obstacle data to the base station;
translating, by the base station, the obstacle data into muscular stimulation commands and transmitting the muscular stimulation commands to the NMESF control unit mounted on user's forearm; and
generating, by the NMESF control unit, force feedback stimulation to influence the user's hand movement that in turn controls the drone through the DCTF module.

15. The method of claim 13, further comprising constituting a visual feedback loop by:
receiving real-time video signals from the camera integrated in the drone; and
transmitting the video signals to the virtual reality headset of the user to facilitate the user to set the hand orientation for drone control.
